(19) United States
(12) Patent Application Publication
(10) Pub. No.: US 2016/0053781 A1
(43) Pub. Date: Feb. 25, 2016

(54) HYDRAULIC SYSTEM WITH SUPPRESSOR UNIT

(71) Applicant: Caterpillar Inc., Peoria, IL (US)

(72) Inventors: Scott R. Fredrickson, Peoria, IL (US); Joseph Bobchik, Edwards, IL (US); Pravin Sondkar, Dunlap, IL (US)

(73) Assignee: Caterpillar Inc., Peoria, IL (US)

(21) Appl. No.: 14/929,442

(22) Filed: Nov. 2, 2015

(51) Int. Cl. F15B 21/00; F15B 11/10; F15B 1/26

(52) U.S. Cl. CPC F15B 21/008; F15B 1/26; F15B 11/10

(57) ABSTRACT

A hydraulic system with a suppressor unit is provided. The hydraulic system includes a reservoir and a hydraulic pump. The hydraulic pump supplies the fluid at a predefined pressure. The hydraulic system includes a hydraulic actuator connected to the hydraulic pump. The hydraulic system also includes a suppressor unit disposed between the hydraulic pump and the hydraulic actuator. The suppressor includes a housing member and a resilient member. The housing member includes a wall member having an inner wall surface and an outer wall surface. The resilient member is disposed within the wall member. The resilient member includes a body having an inner surface and an outer surface. The inner surface defines a passage for fluid flow therethrough. The outer surface includes at least one protrusion having an end surface. The end surface abuts to the inner wall surface of the housing member.

### TECHNICAL FIELD

The present disclosure relates to a hydraulic system, and more specifically to the hydraulic system with a suppressor unit for damping ripples created in a flow of fluid.

### BACKGROUND

Hydraulic systems are generally used as a source of power transmission in various applications, such as in industrial machinery, in off-road vehicles, in automotive systems, and in aircrafts. A hydraulic system usually includes a pump to drive a fluid within the hydraulic system. The pump generates high amplitude pressure ripples in a flow of the fluid mainly due to a cyclical nature of the pumping process. The high amplitude pressure ripples result in an undesirable fluid-borne noise in the hydraulic system. The high amplitude pressure ripples may also cause damage to components of the hydraulic system. In order to eliminate such fluid-borne noise, a suppressor is disposed in the hydraulic system that dampens the high amplitude pressure ripples. However, existing suppressors include a large number of components, which would lead to a complex structure of the suppressors. Also, existing suppressors include a large number of contact points between the components that leads to internal wear, thereby reducing the suppressors' life and increasing the maintenance cost. The maintenance of existing suppressors is cumbersome and time consuming

Japanese Patent Application Number 2004-083772, hereinafter referred to as '772 application, describes a pulsation-preventing apparatus used for reducing the pulsation of a pressure fluid in a pressure piping system, particularly a pulsation absorbent efficiently absorbing pressure and flow rate pulsation of the pressure fluid which flows in the interior of piping. The pressure pulsation absorbing foam enabling absorption of the pulsation is formed by arranging foam composed of a fluorine rubber elastomer and having closed cells in a pressure circuit. Thereby, pulsation absorption of a frequency having a broad width is made possible. However, the apparatus of '772 application is not effective in damping high amplitude pressure ripples in the fluid flow at high mean pressures.

### SUMMARY OF THE DISCLOSURE

In one aspect of the present disclosure, a hydraulic system is provided. The hydraulic system includes a reservoir for storing a fluid. The hydraulic system also includes a hydraulic pump that is in communication with the reservoir. The hydraulic pump supplies the fluid at a predefined pressure. The hydraulic system includes a hydraulic actuator that is in communication with the hydraulic pump to receive the fluid at the predefined pressure. The hydraulic pump is connected to the hydraulic actuator through a fluid duct. The hydraulic system also includes a suppressor unit disposed in the fluid duct between the hydraulic pump and the hydraulic actuator. The suppressor unit is configured to dampen ripples created in a flow of the pressurized fluid. The suppressor unit includes a housing member. The housing member includes a wall member defining an inner wall surface and an outer wall surface distal to the inner wall surface. The housing includes a first end member and a second end member spaced apart from the first end member. The first end member and the second end member disposed adjacent to a first end and a second end of the wall member, respectively. The housing also includes an inlet port and an outlet port defined adjacent to the first end and the second end, respectively. The inlet port is communicated with the hydraulic pump and the outlet port is communicated with the hydraulic actuator. The suppressor unit also includes a resilient member disposed within the wall member of the housing member. The resilient member includes a body having an inner surface and an outer surface. The inner surface defines a passage for receiving the pressurized fluid therethrough. The outer surface faces the inner wall surface of the wall member of the housing member. The body includes a first end configured to abut the first end member and a second end configured to abut the second end member. The resilient member also includes at least one protrusion extending from the outer surface of the resilient member to an end surface. The end surface of at least one protrusion abuts the inner wall surface of the housing member. The end surface has one of a triangular cross-section, a hexagonal cross-section, a rectangular cross-section, a circular cross-section, and a square cross-section. The at least one protrusion compresses, when the resilient member expands towards the inner wall surface of the wall member of the housing member for damping the ripples in the flow of the pressurized fluid.

Other features and aspects of this disclosure will be apparent from the following description and the accompanying drawings.

### BRIEF DESCRIPTION OF THE DRAWINGS

FIG. 1 is a schematic diagram of a hydraulic system, according to an embodiment of the present disclosure;

FIG. 2 is a sectional view of a suppressor unit used with the hydraulic system of FIG. 1, according to an embodiment of the present disclosure;

FIG. 3 is a side sectional view of the suppressor unit used with the hydraulic system of FIG. 1, according to an embodiment of the present disclosure;

FIG. 4 illustrates a rectangular cross section of an end surface with protrusions, according to an embodiment of the present disclosure;

FIG. 5 illustrates a square cross section of an end surface of the protrusions, according to an embodiment of the present disclosure; and

FIG. 6 illustrates a hexagonal cross section of an end surface of the protrusions, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

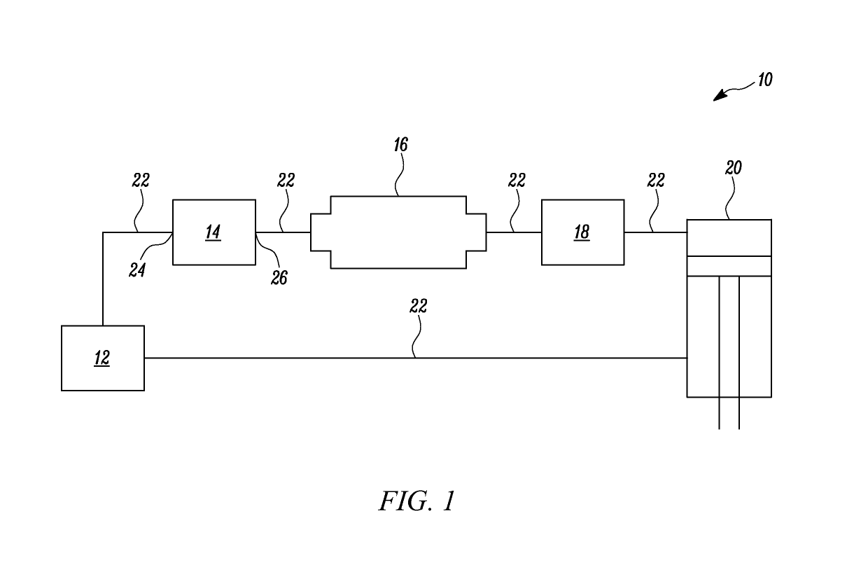

FIG. 1 is a schematic diagram of a hydraulic system 10, according to an embodiment of the present disclosure. The hydraulic system 10 includes a reservoir 12 for storing a fluid, a hydraulic pump 14 connected to the reservoir 12, a suppressor unit 16 for damping ripples in a flow of the fluid, a control valve 18 for controlling the fluid flow, and a hydraulic actuator 20. The hydraulic system 10 can alternatively include other components and is not limited to those described herein.

The reservoir 12 is connected to the hydraulic pump 14 through a fluid duct 22. The reservoir 12 stores excess fluid to accommodate volume changes due to actuation of the hydraulic actuator 20, temperature driven expansion and contraction, and fluid leakage. The dimensions of the reservoir 12 may vary based on a type of the hydraulic system 10, re-usability of the fluid, and mobility of the hydraulic system 10.

The hydraulic pump 14 is driven by a power source (not shown). The hydraulic pump 14 includes an inlet 24 and an outlet 26. The inlet 24 is connected to the reservoir 12 through the fluid duct 22. The outlet 26 is connected to the suppressor unit 16. The hydraulic pump 14 propels the fluid from the reservoir 12 to the suppressor unit 16 at a predefined pressure. The predefined pressure is selected based on a number of parameters. The number of parameters may include, but is not limited to, a type of the hydraulic actuator 20 and a size of the hydraulic system 10.

The suppressor unit 16 receives the pressurized fluid with high amplitude pressure ripples from the outlet 26 of the hydraulic pump 14. The high amplitude pressure ripples are formed in the flow of the pressurized fluid due to a number of parameters. The number of parameters may include, but is not limited to, a type of the hydraulic pump 14, a number of hydraulic pumps 14, a hydraulic pump pressure, a hydraulic pump size, a hydraulic pump speed, and a number of pumping elements, such as pistons, gear teeth, and vanes. The suppressor unit 16 dampens the high amplitude pressure ripples in the fluid flow. The suppressor unit 16 supplies the pressurized fluid with low amplitude pressure ripples to the control valve 18. The control valve 18 is provided for controlling the fluid flow exiting from the suppressor unit 16. The control valve 18 is further connected to the hydraulic actuator 20 through the fluid duct 22.

The hydraulic actuator 20 is a double-acting cylinder. In one example, the hydraulic actuator 20 may be a hydraulic cylinder or any other suitable implement device used for raising, lowering, or otherwise moving a component of the machine.

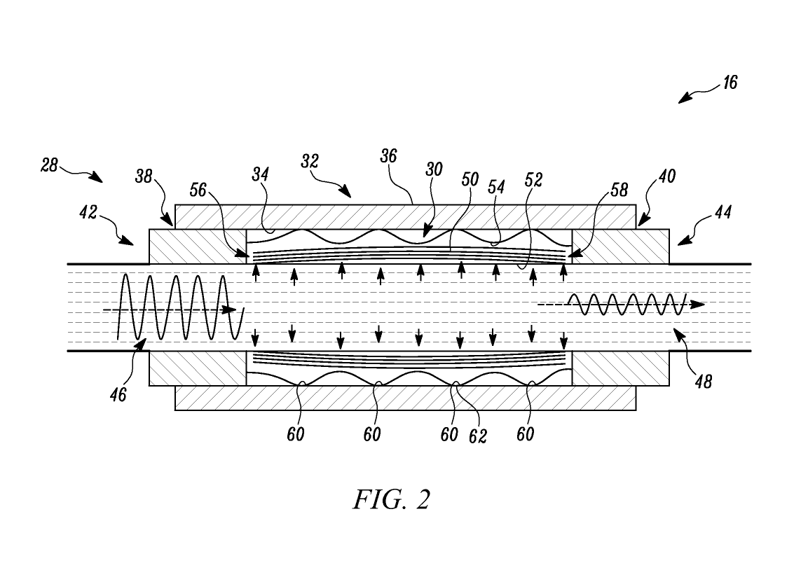

FIG. 2 is a sectional view of the suppressor unit 16. The suppressor unit 16 includes a housing member 28 and a resilient member 30 disposed within the housing member 28. The suppressor unit 16 receives the pressurized fluid with the high amplitude pressure ripples. The housing member 28 is made of steel, and has a cylindrical cross-section. The housing member 28 includes a wall member 32. The wall member 32 includes an inner wall surface 34 and an outer wall surface 36 distal to the inner wall surface 34. The wall member 32 has a first end 38 and a second end 40 spaced apart from the first end 38. The housing member 28 also includes a first end member 42 and a second end member 44 spaced apart from the first end member 42. The first end member 42 is positioned adjacent to the first end 38 of the wall member 32. The second end member 44 is positioned adjacent to the second end 40 of the wall member 32.

The housing member 28 includes an inlet port 46 and an outlet port 48. The inlet port 46 is defined adjacent to the first end 38 of the wall member 32. The outlet port 48 is defined adjacent to the second end 40 of the wall member 32. The inlet port 46 is connected to the hydraulic pump 14 of the hydraulic system 10. The inlet port 46 receives the pressurized fluid with high amplitude pressure ripples from the hydraulic pump 14. The outlet port 48 is connected to the control valve 18 through the fluid duct 22.

The resilient member 30 is coaxially positioned within the wall member 32 of the housing member 28. The resilient member 30 is made of rubber or any suitable flexible material. In one example, the resilient member 30 may be made of any suitable elastomer known in the art. The resilient member 30 includes a body 50 having an inner surface 52 and an outer surface 54. The inner surface 52 defines a passage for receiving the pressurized fluid therethrough. The outer surface 54 faces the inner wall surface 34 of the wall member 32 of the housing member 28. The body 50 includes a first end 56 and a second end 58. The first end 56 abuts the first end member 42 of the housing member 28. The second end 40 abuts the second end member 44 of the housing member 28. The outer surface 54 of the body 50 includes a number of protrusions 60 having an end surface 62. The end surface 62 abuts the inner wall surface 34 of the housing member 28. The protrusions 60 extend from the outer surface 54 of the resilient member 30 to the end surface 62.

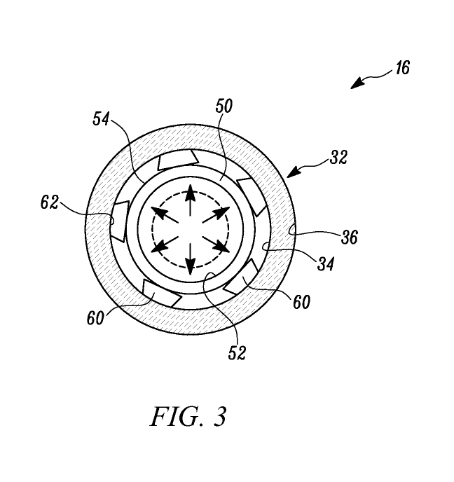

FIG. 3 is a side sectional view of the suppressor unit 16. Referring to FIG. 2 and FIG. 3, upon receiving the fluid with high amplitude pressure ripples, the body 50 of the resilient member 30 expands radially outward in the housing member 28. The expansion of the body 50 absorbs energy from the high amplitude pressure ripples in the fluid, thereby damping the high amplitude ripples. The expansion of the body 50 results in a compression of the protrusions 60 against the inner wall surface 34 of the housing member 28.

The protrusions 60 formed on the outer surface 54 provides rigidity to the resilient member 30 that enables the resilient member 30 to maintain a static pressure in the hydraulic system 10. More specifically, a combination of expansion and compression of the body 50 and the protrusions 60, respectively, dampen the high amplitude pressure ripples without affecting the static pressure in the hydraulic system 10.

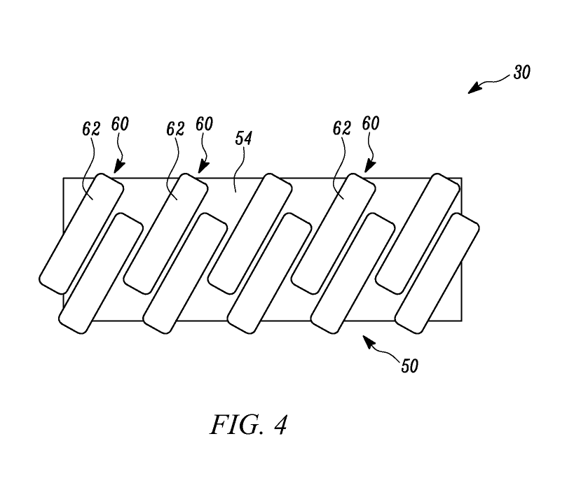

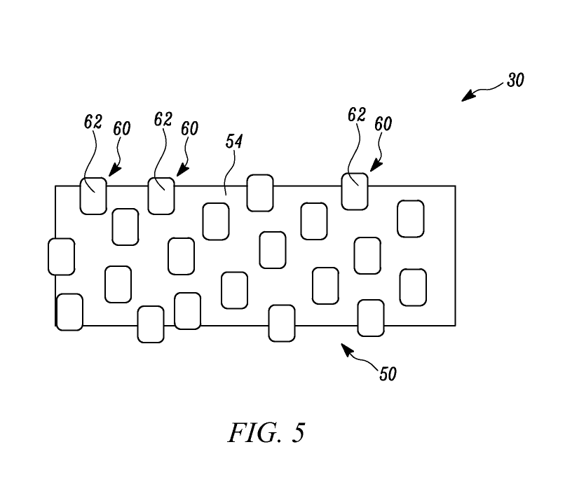

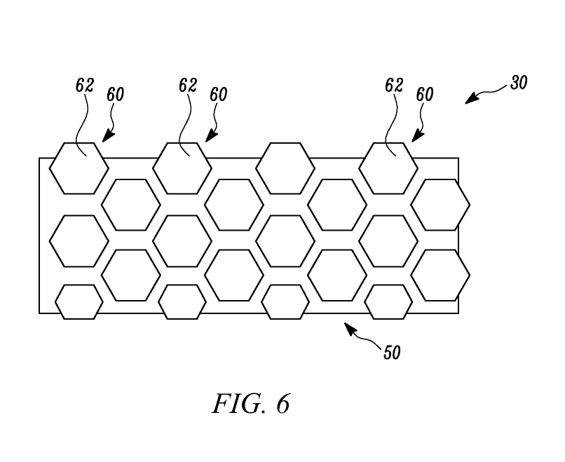

FIG. 4 illustrates a rectangular cross section of the end surface 62 of the protrusions 60. FIG. 5 illustrates a square cross section of the end surface 62 of the protrusions 60. FIG. 6 illustrates a hexagonal cross section of the end surface 62 of the protrusions 60. The shape of the end surface 62 is not limited to the square cross section, the rectangular cross section, and the hexagonal cross section. The shape of the end surface 62 may vary based on operational characteristics of the hydraulic system 10. The operational characteristics include, but are not limited to, an operating pressure, environmental factors, and a type of fluid. The dimension of the protrusions 60 may vary based on dimensional characteristics of the suppressor unit 16. The protrusions 60 enable the suppressor unit 16 to endure the high static pressure without compromising the ability of the suppressor unit 16 to dampen high amplitude pressure ripples.

The hydraulic system 10 may be used in a machine, such as an excavator, a loader, or any other machine. In one example, the hydraulic system 10 may be employed in a conveyor system, a material handling system, and a packaging system.

In one example, the hydraulic pump 14 may be electronically powered. In another example, the hydraulic pump 14 may be powered by an engine of the machine. In one example, the hydraulic pump 14 may include, but is not limited to, a vane type pump, a gear type pump, a piston type pump or a screw type pump.

In one example, the hydraulic actuator 20 may include, but is not limited to, a ram cylinder, a single acting cylinder, a tandem cylinder, a telescopic cylinder, and a duplex cylinder. In another example, the hydraulic actuator 20 may include, but is not limited to, a vane type motor, a gear type motor, and a piston type motor. Although, the present disclosure is described with respect to the double-acting cylinder, the present disclosure is not limited to a cylinder, a hydraulic motor, and the hydraulic actuator 20.

In one example, the housing member 28 may be made of a metallic or a non metallic material known in the art. In one example, the shape of the end surface 62 of the protrusions 60 may be a triangular cross-section. In another example, the shape of the end surface 62 of the protrusions 60 may be a circular cross-section.

### INDUSTRIAL APPLICABILITY

The present disclosure relates to the suppressor unit 16 mounted in the hydraulic system 10 for damping the high amplitude pressure ripples. The suppressor unit 16 includes the housing member 28 and the resilient member 30. The resilient member 30 is positioned within the wall member 32 of the housing member 28. The resilient member 30 includes the body 50 having the inner surface 52 and the outer surface 54. The inner surface 52 defines the passage for receiving the pressurized fluid. The outer surface 54 faces the inner wall surface 34 of the housing member 28. The outer surface 54 includes the protrusions 60 extending from the outer surface 54 of the resilient member 30. The shape of the protrusions 60 may vary based on the operational characteristics of the hydraulic system 10.

The protrusions 60 enable the suppressor unit 16 to dampen the high amplitude pressure ripples without affecting the predefined pressure of the fluid in the hydraulic system 10. The suppressor unit 16 can be employed in any type of the hydraulic system 10 for damping the high amplitude pressure ripples in the pressurized fluid. Therefore, the suppressor unit 16 has a wide range of application across industries. The suppressor unit 16 can be positioned at any location in the hydraulic system 10. This would provide the suppressor unit 16 with a flexibility of installation. The suppressor unit 16 includes fewer components that reduce contact points between the components, thereby reducing the internal wear. The present disclosure offers the suppressor unit 16 that is simple, effective, easy to use, economical and time saving.

While aspects of the present disclosure have been particularly shown and described with reference to the embodiments above, it will be understood by those skilled in the art that various additional embodiments may be contemplated by the modification of the disclosed remote operating station without departing from the spirit and scope of what is disclosed. Such embodiments should be understood to fall within the scope of the present disclosure as determined based upon the claims and any equivalents thereof.

What is claimed is:

1. A hydraulic system comprising:
a reservoir for storing a fluid;
a hydraulic pump in communication with the reservoir, the hydraulic pump configured to supply the fluid at a predefined pressure;
a hydraulic actuator configured to communicate with the hydraulic pump to receive the fluid at the predefined pressure, wherein the hydraulic pump is connected to the hydraulic actuator through a fluid duct; and
a suppressor unit disposed in the fluid duct between the hydraulic pump and the hydraulic actuator, the suppressor unit configured to dampen ripples created in a flow of the pressurized fluid, the suppressor unit comprising:
a housing member comprising:
a wall member defining an inner wall surface and an outer wall surface distal to the inner wall surface;
a first end member and a second end member spaced apart from the first end member, the first end member and the second end member disposed adjacent to a first end and a second end of the wall member, respectively; and
an inlet port and an outlet port defined adjacent to the first end and the second end, respectively, wherein the inlet port is communicated with the hydraulic pump and the outlet port is communicated with the hydraulic actuator; and
a resilient member disposed within the wall member of the housing member, the resilient member comprising:
a body having an inner surface defining a passage for receiving the pressurized fluid therethrough and an outer surface facing the inner wall surface of the wall member of the housing member, wherein the body comprises a first end configured to abut the first end member and a second end configured to abut the second end member; and
at least one protrusion extending from the outer surface of the resilient member to an end surface, wherein the end surface of the at least one protrusion abuts the inner wall surface of the housing member and has one of a triangular cross-section, a hexagonal cross-section, a rectangular cross-section, a circular cross-section, and a square cross-section, and
wherein the at least one protrusion compresses, when the resilient member expands towards the inner wall surface of the wall member of the housing member for damping the ripples in the flow of the pressurized fluid.
